(19) United States
(12) Patent Application Publication
(10) Pub. No.: US 2005/0277104 A1
(43) Pub. Date: Dec. 15, 2005

(54) Automatic cutting machine teaching device

(76) Inventors: Shinji Morimoto, Wakayama-shi (JP); Kazunari Hama, Wakayama-shi (JP)

Correspondence Address: ROTHWELL, FIGG, ERNST & MANBECK, P.C., 1425 K STREET, N.W., SUITE 800, WASHINGTON, DC, 20005, US

(21) Appl. No.: 10/522,184

(22) PCT Filed: Jul. 22, 2003
(86) PCT No.: PCT/JP03/09294

§ 371 Date: Jan. 24, 2005

(30) Foreign Application Priority Data
Jul. 26, 2002 (JP) 2002-217473

(51) Int. Cl. G09B 25/00

(52) U.S. Cl. 434/365

(57) ABSTRACT

An automatic cutting machine teaching device includes image processing means and judgment means. The image processing means displays an image of a cutting area on a monitor and superimposes a cutting pattern of corrected making data on a position corresponding to the image of the cutting area displayed on the monitor. The judgment means judges whether the cutting pattern is entirely contained within the cutting area. If the cutting pattern is not entirely contained in the cutting area, the judgment means decides to cause an error and displays a portion of the cutting pattern out of the cutting area on the monitor.

### FIELD OF THE INVENTION

The present invention relates to an automatic cutting machine for cutting a sheet material such as cloth or a knitted fabric into desired patterns, and in particular, relates to teaching process for a sheet placed in a cutting area of a cutting table thereof.

### BACKGROUND OF THE INVENTION

A sheet such as cloth or a knitted fabric is spread on a spreading table provided on the upstream side of a cutting machine and then is carried in and onto a cutting table of a cutting machine, or is placed directly on the cutting table. The sheet placed on the cutting table is to be cut according to a predetermined cutting pattern by means of a cutter or the like. The sheet, however, is placed off a regular position in many cases.

Accordingly, it has been known to designate a base in marking data, and for example, to determine a base of a sheet plated on a cutting table by designating the position with a laser marker provided on a cutting head of the cutting machine, and to make correction so that the base of the marking data is aligned with the base position of the sheet. Moreover, it has been known to designate at least one more point other than the base point of the sheet in an edge part of the sheet, the part being away from the base point of the sheet, to compute the slope or tilt of the sheet in relation to the cutting table and to correct the marking data according to the calculated slope of the sheet. In this way, if the sheet placed on the cutting table is off a regular position, the sheet can be cut into the desired pattern, and cutting can be done to match the intrinsic directions of the sheet caused by the directions of the threads, etc. Such a process is generally called teaching.

Depending on the place of a sheet, however, the cutting pattern stored in marking data may come out of the cutting area, the available area of a cutting table for cutting. If cutting is done under such a condition, the sheet cannot be cut into the desired pattern and the sheet will be wasted. Accordingly, it is essential to place the sheet on the cutting table so that the cutting pattern is contained in the cutting area. It, however, is difficult sometimes to judge whether the cutting pattern is contained in the cutting area by merely observing the sheet placed on the cutting table.

Whether the cutting pattern is contained in the cutting area is checked, up to the present, by illuminating before cutting the circumference of a rectangular marking area containing the cutting pattern with a laser marker provided on the cutting head, or by moving the cutting head while a cutter thereof being raised into an inoperative position and with the laser marking thereof illuminating according to the cutting route stored in the marking data.

The above-mentioned checking works, however, take time, and moreover, the operator cannot check which cutting pattern is out of the cutting area and to what extent it is out. Furthermore, when it is found that the cutting pattern is not contained in the cutting area, the operator must place the sheet on the cutting table again or give an appropriate instruction to the cutting machine to move the sheet to a better position.

### SUMMARY OF THE INVENTION

### OBJECTS OF THE INVENTION

An object of the present invention is to provide a teaching device for an automatic cutting machine, where it is easily judged whether a cutting pattern is contained in the cutting area of the cutting machine. Another object of the invention is to provide an automatic cutting machine teaching device wherein assistance is given to enable successive cutting work even when a cutting pattern is out of the cutting area.

### CONSTRUCTIONS OF THE INVENTION

In the present invention, a teaching device for an automatic cutting machine having a cutting table and a cutting area on the table for placing a sheet within the area, the teaching device, upon the designation of at least two teaching points on the sheet, computing a position and a slope of the sheet to the cutting area, correcting marking data in accordance with the position and the slope of the sheet, and cutting the sheet with corrected marking data, the teaching device is characterized
by a monitor displaying cutting information, and
by image processing means for making an image of the cutting area displayed on the monitor and for composing a cutting pattern according to the corrected marking data with the image of the cutting area on a corresponding position.

Preferably, after designation of the teaching points and the correction of the marking data, whether the cutting pattern is contained within the cutting area is judged by judgement means and, when the cutting pattern is not entirely contained within the cutting area, an error is judged and a portion out of the cutting area of the cutting pattern is made recognizable displayed on the monitor.

Preferably, the cutting table can move the sheet in a longitudinal direction of the cutting area with driving a conveyor, and subsidiary means for computing a length of the cutting pattern extending out of an edge of the cutting area, upon judgment by the judgment means of the error, and for driving the conveyor for at least the length, when the sheet can be replaced within the cutting area by the movement of the sheet, is provided.

Preferably, subsidiary means for evaluating whether movement of the marking data in position makes the cutting pattern within the cutting area, when the error is judged by the judgement means, and for correcting the marking data so as to confine the cutting pattern within the cutting area, when the movement is evaluated possible, is provied.

Further, in the invention, a teaching device for an automatic cutting machine having a cutting table and a cutting area on the table for placing a sheet within the area, the teaching device, upon the designation of at least two teaching points on the sheet, computing a position and a slope of the sheet to the cutting area, correcting marking data in accordance with the position and the slope of the cutting sheet, and cutting the sheet with corrected marking data, the teaching device is characterized
by judgement means for judging whether the cutting pattern is contained within the cutting area, after designation of the teaching points and the correction of the marking data, and by subsidiary means for evaluating whether movement of the marking data in position makes the cutting pattern within the cutting area, when the error is judged by the judgement means, and for correcting the marking data so as to confine the cutting pattern within the cutting area, when the movement is evaluated possible.

### ADVANTAGES IN THE INVENTION

As described above, according to the present invention, the image processing means makes an image of the cutting area displayed on the monitor, and also makes the cutting pattern of the corrected marking data displayed on the monitor in a position corresponding to and composed with the image of the cutting area.

In this way, one can easily check, on the monitor, the position of the cutting pattern in relation to the cutting area.

According to the present invention, the judgment means judges the state as an error when the cutting pattern is not entirely contained in the cutting area and displays on the monitor the portion of the cutting pattern, out of the cutting area for easy recognition.

With this arrangement, one can easily check, on the monitor, which cutting pattern is out of the cutting area to what extent.

According to the present invention, the cutting table can be driven with a conveyor in the longitudinal direction of the cutting area, and when the judgment means judges that the cutting pattern is out of the cutting area in the longitudinal direction thereof, the subsidiary means will compute the length of the cutting pattern out of the cutting area. Then, if it is possible to bring the cutting pattern into the cutting area by shifting the sheet, the subsidiary means will drive the conveyor by at least the length that the cutting pattern is out of an edge of the cutting area to bring the cutting pattern entirely into the cutting area.

With this arrangement, the processing for avoiding an error can be done automatically, enabling cutting process successively after the judgment of the error.

According to the present invention, when the judgment means judges that the cutting pattern is out of the cutting area, the subsidiary means will operate to check whether the cutting pattern can be brought into the cutting area without coming out of the sheet by shifting the marking data, and if the cutting pattern can be brought into the cutting area, the subsidiary means will correct the marking data.

With this arrangement, the processing for avoiding an error can be done automatically, enabling cutting process successively after the judgment of the error.

According to the present invention, after the designation of the teaching points and correction of the marking data, the judgment means judges whether the cutting pattern is entirely contained in the cutting area. When the judgment means judges that the cutting pattern is out of the cutting area, the subsidiary means will operate to check whether the cutting pattern can be brought into the cutting area without coming out of the sheet by shifting the marking data, and if the cutting pattern can be brought into the cutting area, the subsidiary means will correct the marking data.

With this arrangement, as the cutting machine makes judgment whether the cutting pattern is entirely contained in the cutting area, and execute the processing for avoiding the error in case the cutting pattern is out of the cutting area, the teaching process can be done easily.

### BRIEF DESCRIPTION OF THE DRAWINGS

FIG. 1 is a schematic diagram illustrating the outline of the cutting machine of the present invention.

FIG. 2 is a diagram schematically illustrating the system configuration of the cutting machine.

FIG. 3 is a flow chart illustrating the flow of the teaching process in the first embodiment of the present invention.

FIG. 4 is a diagram illustrating a display of the sheet placed state display in the first embodiment.

FIG. 5 is a flow chart illustrating the flow of the teaching process in the second embodiment of the present invention.

FIG. 6 is a diagram illustrating a display in the monitor how the sheet is placed in the second embodiment.

### EMBODIMENTS

### EXAMPLE 1

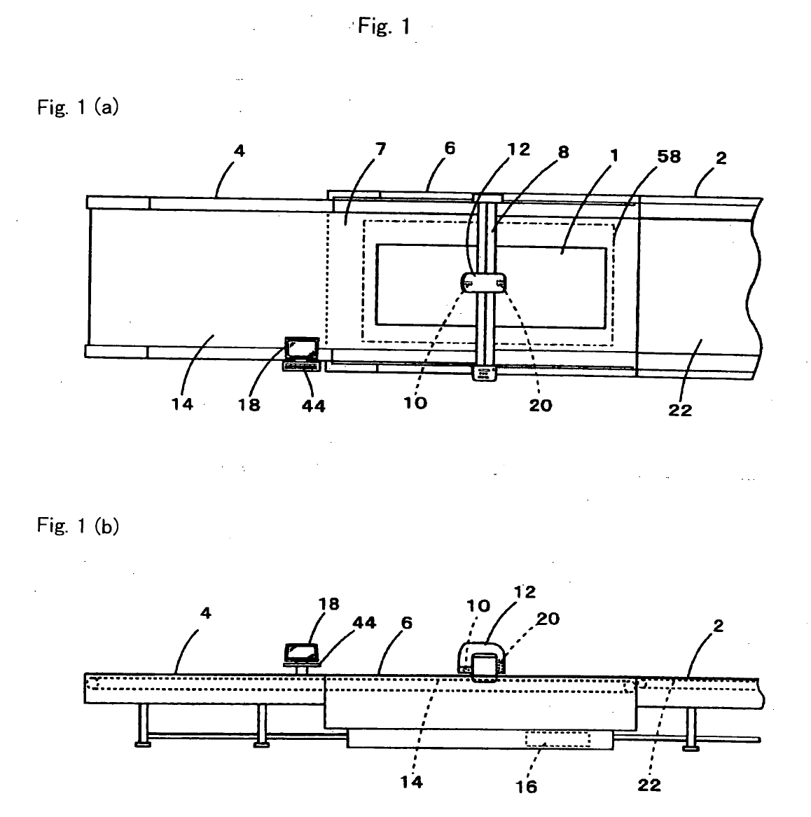

In the following, one embodiment of the present invention will be described with reference to the drawings. FIG. 1 is a schematic diagram illustrating a cutting machine 6, provided with a spreading table 2 on the carry-in side for a sheet 1, and with a pick-up table 3 on the carry-out side for the sheet 1. FIG. 1(a) is a plan view, and FIG. 1(b) is a side view. The cutting machine 6 is provided with a cutting carriage 8 that can move over a cutting table in the longitudinal direction thereof. A cutting head 12 having a cutter 10 for cutting the sheet 1 is so provided on the cutting carriage that the cutting head 12 can move on the cutting carriage 8. The cutting table 7 is formed of an air-permeable conveyor belt 14 and can hold, by vacuum suction, a sheet 1 that is placed on the cutting table 7. The surface of the sheet 1 is covered by an impermeable cover sheet, not illustrated, such as polyethylene, drawn out of a sheet roll. While the sheet 1 is held on the cutting table 7 by vacuum suction, it is cut by the cutter 10 provided on the cutting head 12. The impermeable cover sheet is cut together with the sheet 1 by the cutter 10 of the cutting head 12. 58 denotes a cutting area.

In this embodiment, the cutter 10 provided on the cutting head 12 is a round circular cutter, having an axis of rotation parallel to the surface of the cutting table 7. Its circumferential blade is made to penetrate and cut the sheet 1. The cutter 10, however, may be a reciprocating straight cutter.

16 is a controller for controlling the cutting machine 6, and information on cutting is displayed on a monitor 18. 44 denotes an operator input for operating the cutting machine, such as a keyboard. The cutting head 12 is provided with a CCD camera, besides the round cutter 10. During teaching, a surface image of the sheet 1 and a reference mark at the center of the screen are composed on the monitor 18. The cutting head 12 is moved so that a teaching point in the sheet 1 overlaps the reference mark, and thus the teaching point is designated.

The spreading table 2 is installed on the sheet carry-in side of the cutting machine 6. While cutting by the cutting machine 6 is in progress, another sheet to be cut next is spread on the spreading table 2. This spreading table also has a conveyor belt 22. When the sheet 1 is carried into the cutting machine 6, the conveyor belt 14 of the cutting machine 6 and the conveyor belt 22 of the spreading table 2 are both driven. On the carry-out side of the cutting machine 6, the pick-up table 4 is installed, and the pick-up table 4 has also the conveyor belt. In the present embodiment, the conveyor belt 14 is common for both the cutting table 7 and the pick-up table 4. The sheet 1, cut on the cutting table 7, is carried out onto the pick-up table 4 with driving the conveyor belt 14. At the same time, the conveyor belt 22 of the spreading table 2 is also driven to carry in a new sheet 1 cut next onto the cutting table 7.

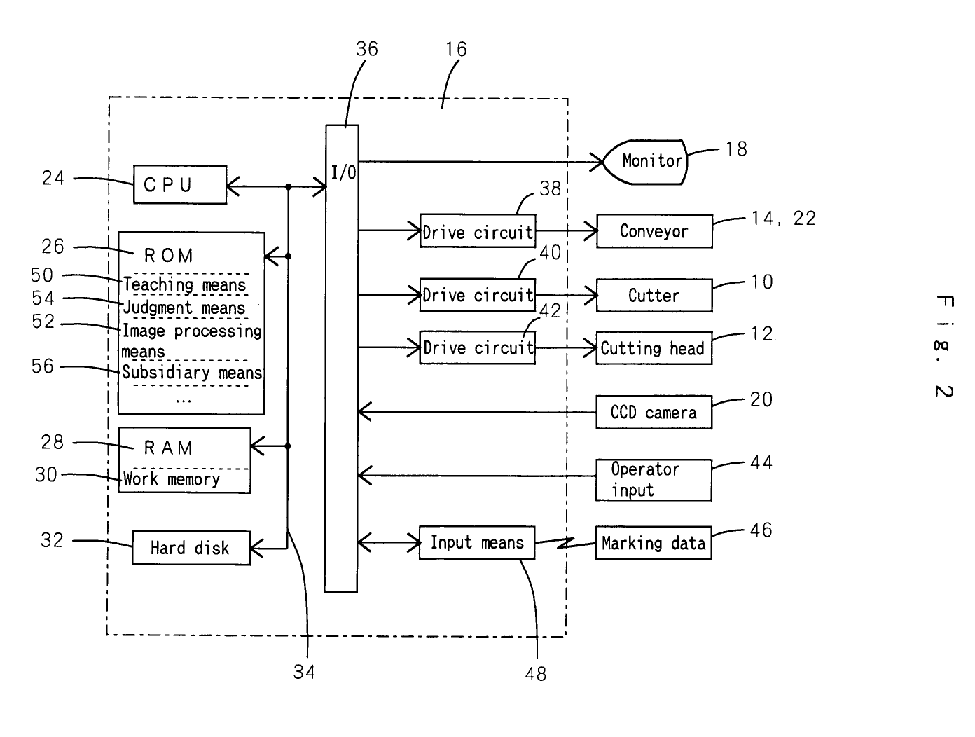

FIG. 2 is a diagram schematically illustrating the system configuration of the cutting machine 6. 24 denotes a CPU for executing general data processing. 26 denotes a ROM storing necessary programs. 32 denotes a hard disk for storing marking data and the like. 34 denotes a bus, here indicated as a single bus without the discretion of data and instruction buses. 36 denotes an input/output interface. 38 denotes a drive circuit for controlling conveyor belt 14 of the cutting table 7 and the pick-up table 4 and the conveyor belt 22 of the spreading table 2. The drive circuit 40 controls the cutter 10. The drive circuit 42 controls the cutting head 12 having the cutter 10 and the CCD camera 20. The drive circuits 38, 40 and 42, the monitor 18 comprising an LCD or the like for displaying information regarding the cutting machine 6, the operator input 44, such as a keyboard for operating the cutting machine 6, an input means 48 for inputting into a marking data storage 46 marking data prepared by a CAD device or the like, and others are connected to the input/output interface 36. As for the marking data storage 46, parts data of respective parts for a garment or the like are efficiently laid out within the marking area, based on the necessary length and the width of the sheet 1, set in advance. The marking data storage 46 stores coordinate positions of the respective cutting patterns P. The marking data storage 46 also stores the base positions as the starting point of cutting. Devices, namely, the conveyor belts 14, 22, the cutter 10, and the cutting head 12 are connected to the drive circuits 38, 40, 42, respectively.

Programs for teaching means 50, image processing means 52, judgment means 54, subsidiary means 56, etc. are stored in the ROM 26. The CPU 24 executes these programs by reading them out of the ROM 26. The teaching means 50, when designated at least two teaching points A, B of the sheet 1 placed on the cutting table 7, computes the base position of the sheet 1 and the slope of the sheet 1 in relation to the cutting area 58. It also corrects the marking data storage 46 to correspond to the computed base position and slope of the sheet 1. As a result, the coordinate positions of the respective cutting patterns P stored in the marking data storage 46 are corrected.

In the present embodiment, when the teaching points A, B of the sheet 1 are designated, the image processing means 52 displays a surface image, not illustrated, of the sheet 1, taken by the CCD camera 20 installed on the cutting head 12, on the camera image display, and composes the reference mark at the center of the camera image display. Designation is made by shifting the cutting head 12 so that the teaching point A or B overlaps with the reference mark. In the present embodiment, the teaching points A, B are designated with the CCD camera 20 installed on the cutting head 12. They, however, may be designated with a laser marker provided in the cutting head 12 illuminating laser beam to the sheet 1.

The image processing means 52 composes the image 59 of the cutting area 58 of the cutting table 7, the cutting patterns P of the marking data storage 46 to be cut, and the image 62 of the sheet 1 based on the data of the necessary length and width of the sheet 1 stored in the marking data storage 46, into the display 60 of the sheet placed on the monitor 18. At this time, the cutting patterns P and the image 62 of the sheet 1 are displayed on the monitor according to the corrected marking data storage 46 in accordance with the base position and slope of the sheet 1 on the cutting table 7, computed by the teaching means 50.

After designation of the teaching points A, B with the teaching means 50, the judgment means 54 judges whether the cutting patterns P of the marking data storage 46 to be cut are entirely with the cutting area 58 with referring to the coordinate positions of the cutting patterns P stored in the marking data storage 46. If the judgment means 54 judges that the cutting patterns P are at least partly out of the cutting area 58, the judgment will be an error. In that case, the judgement means 54 makes the monitor 18 give an error display, and commands the image processing means 52 to display the portion of cutting patterns P out of the cutting area 58 as an inverted image on the monitor 18. With this arrangement, the operator can easily judge whether the cutting patterns P are entirely contained within the cutting area 58. Even when the cutting patterns P are out of the cutting area 58, the operator can recognize, at a glance, which portion of the cutting patterns P is out of the cutting area 58.

The subsidiary means 56 automatically executes a process for avoiding an error when the judgment means 54 judges the state as an error because the cutting patterns P are out of the cutting area 58. For example, when a portion of the cutting patterns P is out of the cutting area 58 in its longitudinal direction only, the subsidiary means 56 will compute by what length the cutting patterns P are out of one end of the cutting area 58, and will drive the conveyor belt 14 of the cutting table 7 by at least the length computed to bring the cutting patterns P into the cutting area 58.

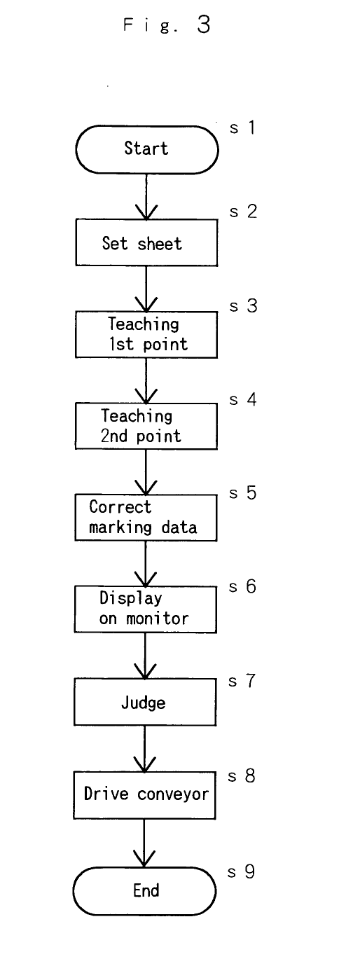

The flow of the teaching process in this embodiment will be described with reference to the flow chart illustrated in FIG. 3. First, the process starts in step s1. In step s2, the conveyor belt 14 of the cutting table 7 and the conveyor belt 22 of the spreading table 2 are driven to carry in the sheet 1 from the spreading table 2 onto the cutting table 7. The conveyor belts 14, 22 are driven by the operator input 44 according to the operator commands. When the sheet 1 seems to be placed within the cutting area 58 of the cutting table 7, the conveyor belts 14, 22 are stopped. Next, the teaching process is started by the teaching means 50. In step s3, the first teaching point of the sheet 1 placed on the cutting table 7, namely, the base position of the sheet is designated. As to the designating method, an image of the sheet surface taken by the CCD camera 20 mounted on the cutting head 12 is displayed on the camera image display, and the cutting head 12 is moved so that the reference mark at the center of the camera image display overlaps with the base position of the sheet 1 to designate the first teaching point A. Then the process proceeds to step s4 to designate an edge part, which is distant from the base position of the sheet 1, as the second teaching point B by a similar method. The errors in the slope of the sheet 1 can be reduced, when the first teaching point A and the second teaching point B are separated by a certain distance.

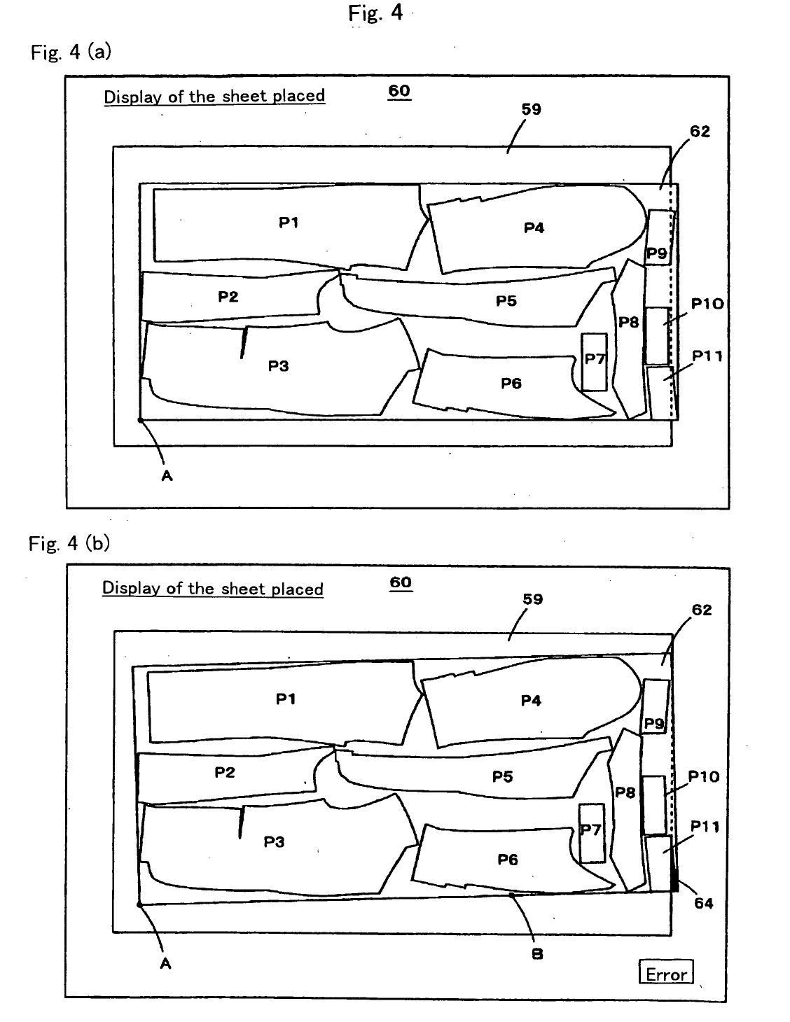

In step s5, when the designation of the second teaching point B is done, the slope of the sheet 1 in relation to the cutting area 58 is computed, and then the marking data storage 46 is corrected in accordance with the base position and the slope of the sheet 1. In step s6, the image processing means 52 displays the image 59 of the cutting area 58 in the display 60 on the monitor 18, with the cutting patterns P1 through P11 of the marking data storage 46 already corrected in step s5, and the image 62 of the sheet 1, which is based on the data of the needed length and the width of the sheet 1 stored in the marking data storage 46, together with the image 59 of the cutting area 58. FIG. 4 is a diagram illustrating one example of the display 60 of the sheet placed.

FIG. 4(a) illustrates the display 60 at the time of designation of the first teaching point A. At this time, the slope of the sheet 1 is not computed yet, hence the cutting patterns P1 through P11 and the image 62 of the sheet 1 without any slope are composed with the image 59 of the cutting area 58 and displayed. As to the display positions of the cutting patterns P1 through P11, they are displayed on the basis of the base position of the sheet 1. When the second teaching point B is designated, the slope of the sheet 1 in relation to the cutting area 58 will be determined. Hence as shown in FIG. 4(b), the cutting patterns P1 through P11 and the image 62 of the sheet 1 to be displayed on the monitor 18 will be corrected according to the slope of the sheet 1 and displayed. At this point, the operator can check, on the monitor 18, the positions of the cutting patterns P1 through P11 in relation to the cutting area 58.

In this embodiment, on the monitor 18, the image 59 of the cutting area 58, the cutting patterns P1 through P11 of the marking data storage 46, and the image 62 of the sheet 1 are composed and displayed. However, display of the image 62 of the sheet 1 on the monitor 18 may be omitted.

In step s7, the judgment means 54 judges whether the cutting patterns P1 through P11 of the marking data storage 46 are entirely contained in the cutting area 58. If any part of the cutting patterns P1 through P11 is out of the cutting area 58, the judgment means 54 will judge the state as an error and display an error on the monitor 18. The judgment means 54 assists the operator to identify at a glance the part of the cutting pattern P being out of the cutting area 58 by, for example, displaying it invertedly. In the case of FIG. 4(b), one can easily see that a right edge part 64 of the pattern P11 is out of the cutting area 58. If in step s7 the judgment means 54 judges that the cutting patterns P1 through P11 are entirely contained in the cutting area 58, the program proceeds to step s9 to terminate the teaching process.

In step s8, if the judgment means 54 judges that the cutting pattern P is out of the cutting area 58 only in the longitudinal direction thereof, the subsidiary means 56 will compute to what extent the cutting pattern P is out of the cutting area and display the result on the monitor 18. And then, if the length of the cutting pattern P out of the cutting area 58 is within an allowable range, the subsidiary means 56 will drive the conveyor belt 14 of the cutting table 7 by at least the length of the cutting pattern P out of the edge of the cutting area to bring the cutting pattern P into the cutting area 58 and, in turn, avoid the error. However, if the cutting pattern P is out of the cutting area 58 in any direction other than the longitudinal direction thereof, avoidance of error can not be achieved by merely driving the conveyor belt 14. Hence the sheet 1 must be placed again on the cutting table 7. Then the program proceeds to step s9 to terminate the teaching process.

In the present embodiment, after designation of the two teaching points A, B, when a portion of the cutting pattern P is out of the cutting area 58 only in the longitudinal direction thereof, the subsidiary means 56 drives the conveyor belt 14 to move the sheet 1 and avoids an error. However, when the designation of the first teaching point A is done, if the judgment means 54 judges that the cutting pattern P is out of the cutting area 58 in the longitudinal direction thereof, the subsidiary means 56 may drive the conveyor belt 14, and after that, the subsidiary means 56 may continue to designate the second teaching point B.

After judgment that the cutting pattern P is not in the cutting area 58, the subsidiary means 56 avoids error, however, the operator may see the place of the sheet 1, displayed on the monitor 18, and may give a command to the cutting machine 6 to avoid an error.

### EXAMPLE 2

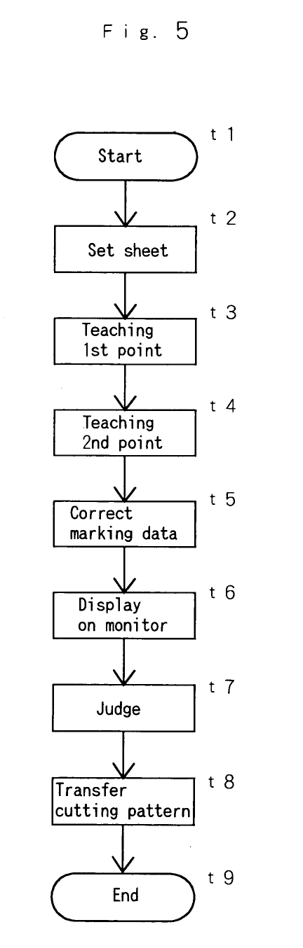

Next, another embodiment of the present invention will be described. FIG. 5 is a flow chart of the teaching process in this embodiment. As step t1 through step t7 are identical to step s1 through step s7 of FIG. 3, description is omitted. In step t7, suppose that the judgment means 54 judges that a portion of the cutting patterns P1 through P11 is out of the cutting area 58. At this time, if the marking data storage 46 sets a marking area with margins at its edges in the top-bottom direction or in the left-right direction in relation to the sheet 1 to be cut, the subsidiary means 56 operates to check whether the cutting patterns P1 through P11 can be brought into the cutting area 58 without coming out of the sheet 1 by moving the position of the marking data storage 46 in the top-bottom direction or in the left-right direction without moving the sheet 1, and then if it is possible to avoid an error, the subsidiary means 56 corrects the marking data storage 46.

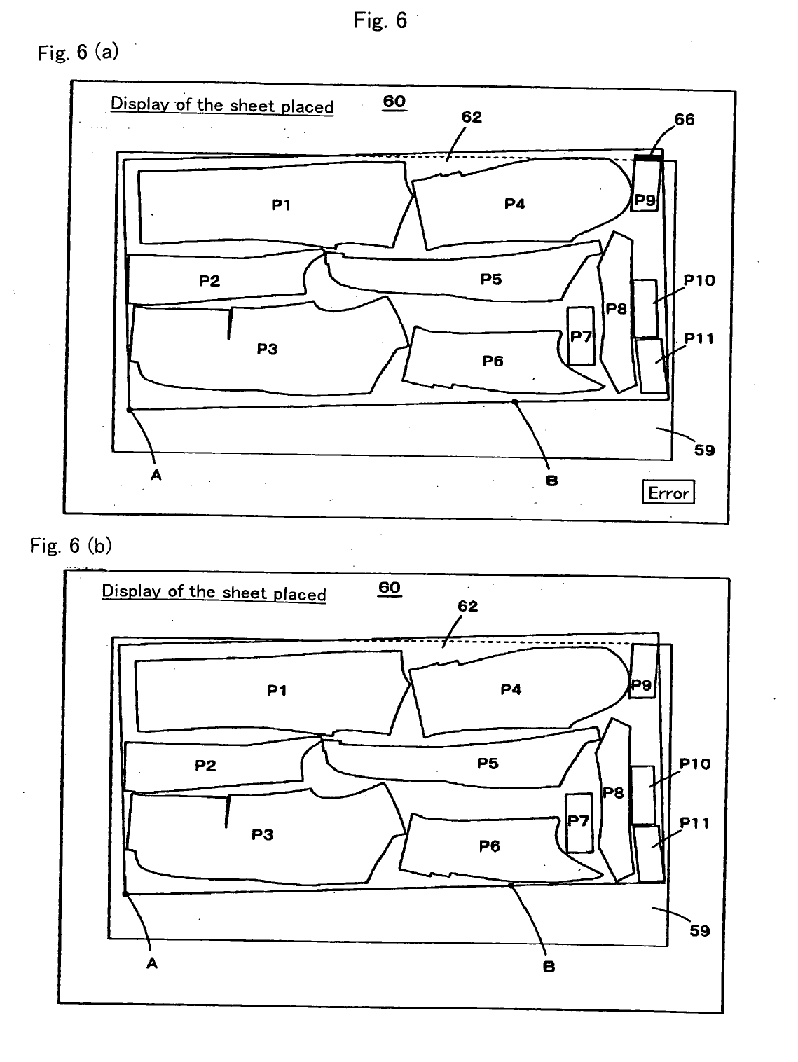

FIG. 6(a) is a diagram illustrating the display 60 of sheet placed on the monitor 18, when an error judgment is given in step t7. In this FIG. 6(a), suppose that an upper part 66 of the cutting pattern P9 is out of the cutting area 58 by 3 mm. However, if the marking data storage 46 prepares the cutting area 58 with margins of 5 mm in relation to the top and bottom ends of the sheet 1, it is possible to bring the cutting patterns P1 through P11 into the cutting area 58 by merely moving the marking data storage 46 downward by 3 mm without moving or replacing the sheet 1. FIG. 6(b) illustrates a state that the marking data storage 46 is moved downward and the cutting patterns P1 through P11 are brought into the cutting area 58. However, if the cutting pattern P is out of the cutting area 58 by more than a margin set in advance, another method must be used.

In this embodiment, the response to the case wherein the cutting pattern P is out of the cutting area 58 in the top-bottom direction was described above. When the cutting pattern P is out of the cutting area 58 in the longitudinal direction thereof, the subsidiary means 56 operates to check whether it is possible to bring the cutting pattern P into the cutting area 58 by moving the marking data storage 46 in the left-right direction, and if error avoidance is possible, the subsidiary means 56 corrects the marking data storage 46.

In this embodiment, when a portion of the cutting pattern P is out of the cutting area 58, all the cutting patterns P are moved by moving the marking data storage 46. However, only the cutting pattern P that is out of the cutting area 58 may be moved. This, however, is limited to a case where there are margins around the cutting pattern P to be moved.

It is possible to combine the first embodiment and the second embodiment. For example, when the cutting pattern P is out of the cutting area 58 in both the longitudinal direction and the top-bottom direction, the cutting pattern P may be brought into the cutting area 58 by both driving the conveyor belt 14 of the cutting table 7 and moving the marking data storage 46 in the top-bottom direction. Possible methods to avoid an error are indicated by the judgment means.

### EXAMPLE 3

Another embodiment will be described. In the embodiments described above, the image 59 of the cutting area 58 and the cutting pattern P of the marking data storage 46 and the image 62 of the sheet 1 are composed and displayed on the monitor 18, and the operator can easily check whether the cutting pattern P is entirely in the cutting area 58. Further more, when the judgment means 54 judges the state as an error because the cutting pattern P is out of the cutting area 58, the subsidiary means 56 executes a process of avoiding that error.

In this embodiment, the image 59 of the cutting are 58, the cutting pattern P, the image 62 of the sheet 1 and so on are not displayed on the monitor 18; after designation of the teaching points A, B, judgment whether the cutting pattern P is contained in the cutting area 58 by the judgment means 54 is displayed on the monitor 18. Then, if the judgment means 54 judges the state as an error because the cutting pattern P is out of the cutting area 58, the subsidiary means 56 operates to check whether it is possible to avoid that error, and if it is possible to avoid the error, the subsidiary means executes the process for that.

As to the process for avoiding the error, as explained in the first embodiment and the second embodiment, if the cutting pattern P is out of the cutting area 58 in the longitudinal direction, the conveyor belt 14 is driven or the marking data storage 46 is moved in the left-right direction to bring the cutting pattern P into the cutting area 58. If the cutting pattern P is out of the cutting area 58 in the top-bottom direction, the marking data storage 46 is moved in the top-bottom direction to bring the cutting pattern P into the cutting area 58.

If the cutting pattern P is not fully in the cutting area 58 even after the subsidiary means 56 executes the process for avoiding the error, the cause of the error and an appropriate method to handle the error are displayed on the monitor 18. For example, when avoidance of error can not be done even if the marking data storage 46 is moved by the subsidiary means 56, because the sheet 1 on the cutting table 7 is placed with a large slope in relation to the cutting area 58, a message that the sheet 1 should be replaced to reduce the slope in relation to the cutting area 58 is displayed on the monitor 18. In this way, as the cutting machine 6 judges, when the sheet 1 is placed on the cutting table 7, whether the cutting pattern P is fully contained in the cutting area 58, and executes process for avoiding error if the cutting pattern P is out of the cutting area 58, the teaching process can be done easily. If the process by the subsidiary means can not avoid an error and the sheet 1 must be placed again, the required handling method is displayed on the monitor 18. Hence the operator can use that handling method.

In the embodiments described above, the spreading table 2 and the pick-up table 4 are provided on the sheet carry-in side and on the carry-out side of the cutting table 7, respectively. The present invention, however, can be executed without such a spreading table 2 or a pick-up table 4. The cutting table 7 has the conveyor belt 14, but the cutting table 7 may be a fixed table without the belt.

The judgment means 54 judges the state as an error when any portion of the cutting pattern P is out of the cutting area 58. This may be changed so that the state is judged as an error when the marking area rather than the cutting pattern P is out of the cutting area 58.

When sheet feed and cutting are to be made, the judgment means 54 may judge whether each segment of the marking data storage 46 is contained in the cutting area 58, and determine the segment for which cutting can be made without replacing the sheet 1, and display the result on the monitor 18. Here, the marking data is divided into plural segments.

The subsidiary means 56 computes to what extent the cutting pattern P is out of the cutting area 58, but this may be done by the judgment means 54.

Preferable embodiments of the present invention were described above. The present invention, however, is not limited to the above-mentioned embodiments and can be executed within the scope of the claims and gist of the present invention.

1. A teaching device for an automatic cutting machine having a cutting table and a cutting area on the table for placing a sheet within the area, the teaching device, upon the designation of at least two teaching points on the sheet, computing a position and a slope of the sheet to the cutting area, correcting marking data in accordance with the position and the slope of the sheet, and cutting the sheet with corrected marking data, said teaching device being characterized
by judgement means for judging whether the cutting pattern is contained within the cutting area, after designation of the teaching points and the correction of the marking data, and
by subsidiary means for evaluating whether movement of the marking data or the sheet in position makes the cutting pattern within the cutting area, when the error is judged by the judgement means, and for correcting the marking data or the sheet relative to the cutting area, when the movement is evaluated possible.

2. A teaching device for an automatic cutting machine according to claim 1, being characterized in
that the cutting table is provided with a conveyor conveying the sheet along a longitudinal direction of the cutting area, and
that, when the error is judged by the judgment means, said subsidiary means computes a length of the cutting pattern extending out of an edge of the cutting area, evaluates whether movement of the sheet in position makes the cutting pattern within the cutting area, and drives the conveyor at least by the length computed, when the movement is evaluated possible.

3. A teaching device for an automatic cutting machine according to claim 1, being characterized in that,
when the error is judged by the judgment means, said subsidiary means evaluates whether movement of the marking data in position makes the cutting pattern within the cutting area and corrects the marking data so as to confine the cutting pattern within the cutting area, when the movement is evaluated possible.

4. (canceled)

5. (canceled)
